(19) United States
(12) Patent Application Publication
(10) Pub. No.: US 2004/0242285 A1
(43) Pub. Date: Dec. 2, 2004

(54) Mobile phone support apparatus

(76) Inventor: Edi Farshi, Cheadle (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/487,883

(22) PCT Filed: Aug. 2, 2002
(86) PCT No.: PCT/GB02/03560

(30) Foreign Application Priority Data
Aug. 29, 2001 (GB) 0120997.2

(51) Int. Cl. H04M 1/00

(52) U.S. Cl. 455/569.2; 455/569.1

(57) ABSTRACT

The present invention provides a mobile phone support apparatus (2) comprising a mobile phone support member (4) and a mounting member (6) for detachably mounting the apparatus to a window of a vehicle. In this way, a mobile phone may be attached to the apparatus (2) and the apparatus (2) mounted on the window of a vehicle such that the mobile phone faces the driver of the vehicle, for safe hands free use of the mobile phone whilst driving. The apparatus may comprise a speaker (18) which in use is oriented to face the windscreen, such that any sound coming through the speaker (18) is reflected from the windscreen in an amphitheater effect in order to amplify the sound.

### FIELD OF THE INVENTION

The invention relates in improvements in mobile phone support apparatus, and methods of mounting a mobile phone to the interior of a vehicle.

### BACKGROUND TO THE INVENTION

The use of mobile phones has expanded rapidly in the past few years, and many members of the public now have their own personal mobile phone for private and business use.

People wishing to use their mobile phones whilst driving a car or other vehicle have traditionally had to pull over to the side of the road and stop the car before being able to pick up and operate the phone safely. Recently “hands-free” accessories haven been made available which allow a vehicle driver to operate his or her mobile phone whilst driving relatively safely, in respect of themselves and other road users. Commonly hands-free accessories generally comprise a mobile phone support apparatus comprising a support frame which is directly plugged into the conventional cigarette lighter socket of the vehicle, the apparatus then protruding from the cigarette lighter socket of the vehicle below the level of the steering wheel. The power from the cigarette lighter socket can be used to power the mobile phone whilst connected to the support frame. Other accessories are designed to be mounted to the front of the dashboard of a vehicle, by way of screws, adhesive or the like.

The driver then operates the mobile phone by pressing the appropriate buttons on the phone whilst driving to make or receive a call. The support apparatus may also comprise a microphone which will allow the driver of the vehicle to speak clearly into the mobile phone on the apparatus without needing to move closer to the mobile phone's own microphone. The support apparatus may also comprise a speaker to amplify the incoming sound from whomever is connected to the mobile phone.

However because conventional mobile phone “hands-free” accessories are mounted on the cigarette lighter socket or dashboard, below the level of the steering wheel, there is still a problem in loss of sound between the user and the speaker/microphone of the accessory. Also, mounting of the accessories on the cigarette lighter socket or dashboard means that access to the mobile phone, when mounted, is relatively awkward as the driver has to reach across and downwards to press any buttons. This could cause problems in safely driving the vehicle if the driver has to lean over and look down to access the phone.

Furthermore, due to the location of the accessory and mobile phone relatively low down in the car, a booster antenna may be needed to enable the mobile phone to adequately receive and transmit signals during use.

It is therefore an aim of preferred embodiments of the present inventions to provide a mobile phone support apparatus which overcomes or mitigates at least one of the disadvantages of the prior art, whether expressly disclosed herein or not.

### SUMMARY OF THE INVENTION

According to a first aspect of the present invention there is provided a mobile phone support apparatus comprising a mobile phone support member and a mounting member for detachably mounting the apparatus to a window of a vehicle.

Preferably the mounting member comprises a windscreen mounting member.

Suitably the mobile phone support member comprises a support frame dimensioned to support a mobile phone.

As the apparatus is arranged to be mounted to a window of the vehicle, a mobile phone connected to the apparatus is situated in an enhanced orientation to receive and transmit data signals through the window, and thus the apparatus and/or mobile phone does not require the use of a separate booster antenna or external antenna to enhance signal pickup and transmission. The apparatus preferably does not comprise a booster antenna and/or external antenna.

The mobile phone support member may comprise attachment means to enable attachment of a mobile phone to the support member. The attachment means may comprise clips, clamps or brackets for example.

The apparatus may comprise at least one speaker and preferably the support member comprises at least one speaker. Preferably the speaker is oriented such that when the apparatus is mounted on the windscreen of a vehicle, the speaker faces towards the windscreen.

Thus, in use, when a mobile phone is attached to the apparatus, any sound generated by the phone may be transmitted through the speaker. If the speaker is facing the a window (in particular the windscreen) of the vehicle, sound transmitted from the speaker will be reflected by the window back into the vehicle and, in the case of the windscreen mounting, be amplified by the natural amphitheatre effect of the windscreen.

Preferably the apparatus comprises means for connecting the speaker to the audio processor and/or audio output connection of an attached mobile phone. Thus, when a mobile phone is connected to the apparatus, incoming sound data into the mobile phone from a third party phone may be transmitted to the speaker of the apparatus and outputted therefrom.

The apparatus may comprise a microphone, and preferably the support member comprises a microphone.

Suitably the microphone is oriented such that when the apparatus is mounted on a vehicle the microphone faces substantially towards the driver of the vehicle.

Thus, in use, when a mobile phone is attached to the apparatus, any sound generated by the driver of the vehicle, when the mobile phone is activated, may be transmitted through the microphone. As the apparatus is mounted to a window of the vehicle, it may be oriented in a favourable position for close proximity of the microphone to the driver, and is above the level of the dashboard and/or steering wheel of the vehicle.

Preferably the apparatus comprises means for connecting the microphone to the audio processor and/or audio input connection of an attached mobile phone. Thus, when a mobile phone is connected to the apparatus, sound generated by the driver of the vehicle may be transmitted into the microphone of the apparatus and into the mobile phone for transmittal to a third party phone.

In an alternative embodiment, the support member may comprise a socket or bracket arranged in use, to receive a separate support frame, which in turn may support a mobile phone. The separate support frame may be as defined above.

The mounting member preferably comprises a suction pad.

Suitably the suction pad comprises a flexible material, such as rubber or a plastics material for example.

The suction pad may comprise means to engage and release suction of the suction pad on the window of a vehicle, when the suction pad contacts the window.

The means for engaging and releasing suction may comprise a lever arranged to move between a first position in which at least part of the lever exerts pressure against the suction pad to effect suction when the pad contacts the window of the vehicle, and a second position in which the pressure is released to allow release of the suction.

The mounting member may be directly connected to the support member, but preferably is spaced apart from the support member by way of a spacing member.

Preferably the spacing member at one end is connected to the mounting member, and at another end is connected to the support member.

The spacing member may comprise a rigid member, such as a rod or cylinder.

The rigid spacing member may be connected to the support member by way of a movable joint or hinge. Suitably the movable joint or hinge allows relative movement between the support member and the spacing member in at least one dimension, preferably at least two dimensions, and most preferably in three dimensions.

Alternatively the spacing member may be a flexible member. When the spacing member is flexible it may be constructed from any suitable material such as rubber, plastics material, flexible metal (including an alloy), or mixtures thereof. The flexible spacing member preferably allows relative movement between the support member and the mounting member in at least one dimension, more preferably at least two dimensions, and most preferably in three dimensions. The spacing member, whether rigid or flexible, may be telescopic to allow movement of the support frame towards and away from the window when the apparatus is attached to the windscreen.

The support member and/or mounting member may be detachable from the spacing member.

Preferably the apparatus further comprises means to connect the apparatus to a vehicle cigarette (or cigar) lighter socket.

The cigarette lighter socket connection means may comprise a plug dimensioned to substantially sealingly fit the cigarette lighter socket of a vehicle.

Suitably the cigarette lighter socket connection means further comprises means to electrically couple the socket to the support member of the apparatus. Thus in use, when the cigarette lighter socket attachment means is connected to the cigarette lighter socket, electrical power may be transmitted through the electrical coupling means into the support member and then into an attached mobile phone in order to power the mobile phone and/or the apparatus.

Preferably the cigarette lighter socket connection means is connected to the support member. Preferably the cigarette lighter socket connection means is connected to the support member by way of a spacing member. Suitably the spacing member is a flexible spacing member, and preferably is a flexible spacing member the length of which can be extended and reduced, to allow connection of the cigarette lighter socket connection means to the cigarette lighter socket of a vehicle when the apparatus is attached to the window of the vehicle in varying positions. A suitable flexible spacing member is an electrical power cord, which may be straight or comprise expandable helical twists therein.

The invention, in a second aspect, extends to a method of mounting a mobile phone to the interior of a vehicle, the method comprising the steps of:

a) providing a mobile phone support member;

b) mounting the mobile phone in the support member;

and

c) attaching the support member to a window of the vehicle.

Steps b) and c) may be temporally interchanged.

Suitably the support member may be as described above.

Preferably the support member is attached to the windscreen of the vehicle.

The method may further comprise the step of connecting the mobile phone to the cigarette (or cigar) lighter socket of the vehicle, which step may be performed at any point in the method.

According to a third aspect of the present invention there is provided the method of the second aspect of the invention, using the apparatus of the first aspect of the invention.

According to a fourth aspect of the invention there is provided a kit of parts comprising a mobile phone support apparatus of the first aspect of the invention and a mobile phone.

### BRIEF DESCRIPTION OF THE DRAWINGS

For a better understanding of various aspects of the invention, and to show how embodiments of the same can be put into effect, preferred embodiments of the invention will now be described with reference to the accompanying diagrammatic drawings, in which:

FIG. 1 illustrates a perspective view of a preferred embodiment of a mobile phone support apparatus of the invention;

FIG. 2 illustrates a perspective view of a second preferred embodiment of a mobile phone support apparatus of the invention; and

FIG. 3 illustrates a perspective view of a third preferred embodiment of a mobile phone support apparatus of the invention.

### DESCRIPTION OF THE PREFERRED EMBODIMENTS

In each of the following descriptions of preferred embodiments of the invention, the mobile phone support apparatus is described as being mounted on the windscreen of a vehicle. Each of the preferred embodiments may also be mounted on any other window of the vehicle, such as the driver's door window, but windscreen mounting provides a more advantageous orientation.

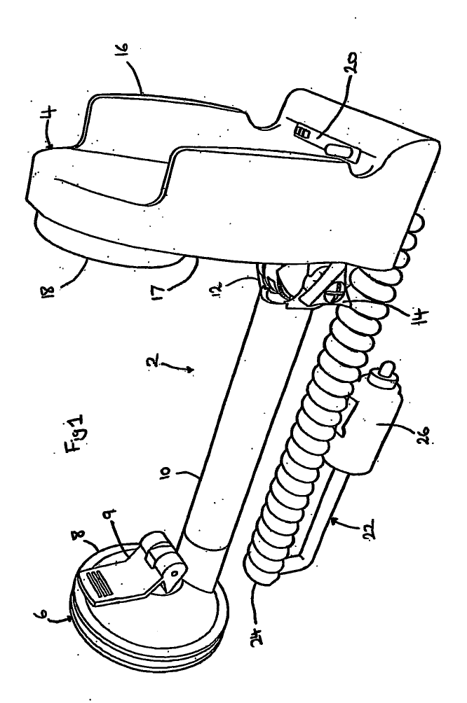

Referring firstly to FIG. 1, a preferred embodiment of a mobile phone support apparatus 2 of the invention comprises a mobile phone support member 4, and a windscreen mounting member 6. The mobile phone support member 4 comprises a support frame 16 which is shaped to receive a mobile phone. The support frame 16, on its rear surface 17 includes a speaker 18. The support frame further comprises an electrical connection plate 20 which is oriented to connect to the electrical connection located on the bottom surface of a mobile phone.

The windscreen mounting member 6 comprises a suction pad 8 to which is attached a pressure lever 9 which is used to provide and release pressure on the suction pad 8 in order to engage and release the suction pad 8 from the windscreen of a car.

The suction pad 8 is connected to the support frame 16 by way of a spacing member in the form of a spacing rod 10. The spacing rod 10 is connected to the support frame 16 by a knuckle joint 12. The knuckle joint 12 allows rotational movement of the support frame 16 about the spacing rod 10, in three dimensions, when the suction pad 8 is attached to the windscreen of a vehicle. The knuckle joint 12 includes an adjustment nut 14 to release and lock movement of the knuckle joint 12 as desired.

The apparatus 2 also comprises a cigarette lighter socket mounting means 22 for attachment of the apparatus 2 to a cigarette lighter socket of a vehicle. The mounting means 22 comprises a flexible, extendible electrical cable 24 which is in electrical communication with the electrical contact plate 20 of the support frame 16, and at its distal end comprises a plug 26 which in use can be inserted into a cigarette lighter socket of a vehicle.

Use of the preferred embodiment of FIG. 1 will now be described.

In use a mobile phone (not shown) is inserted into the support frame 16 such that the electrical connection portion of the mobile phone (generally the portion where an electrical charger may be inserted) is connected to the electrical connection plate 20 of the support frame 16. The apparatus 2 is then connected to the windscreen of a vehicle (not shown) as follows.

The suction pad 8 is pressed against the desired portion of the windscreen and the lever 9 pushed forward to increase pressure on the back of the suction pad 8, causing the suction pad to grip the windscreen with a tight vacuum. The apparatus 2 is then sealingly attached to the windscreen, and can only be removed by pulling back the lever 9 to release the vacuum generated between the suction pad 8 and the windscreen to allow the apparatus to be removed.

When the apparatus 2 is attached to the windscreen, the positioning of the support frame 16 can be adjusted by releasing the adjustment nut 14 on the knuckle joint 12 and rotating the support frame 16 about the knuckle joint 12 to the desired orientation.

The apparatus 2 is then connected to the cigarette lighter socket of the vehicle by extending the electrical cable 24 and inserting the plug 26 in the socket.

When the vehicle is operated power can be transmitted through the cigarette light socket through the plug 26, electrical cable 24 and into the attached mobile phone via the electrical connection plate 20 on the support frame 16, in order to power the mobile phone.

When the phone is switched on and the driver of the vehicle receives or transmits a call, the positioning of the phone is optimised for receipt and transmission of sound due to the orientation of the phone above the dashboard of the vehicle, extending from the windscreen.

When sound is transmitted from the phone, it is transmitted via the speaker 18 on the back surface 17 of the support frame 16. The speaker 18 faces the windscreen of the vehicle in use, due to the orientation of the apparatus 2 when attached to the windscreen. As such, sound transmitted through the speaker 18 will reflect from the windscreen back towards the driver of the vehicle. Most vehicle windscreens are curved and as such the natural amphitheatre effect may help to amplify the sound reflected.

The support frame 16 may also, in an alternative embodiment include a microphone (not shown) on the front face of the frame 16. The microphone, when the apparatus 2 is attached to the windscreen of a vehicle, would face substantially towards the driver of the vehicle in order to pick up and amplify any words spoken by the driver. The positioning of the apparatus 2 on the windscreen of the vehicle above the dashboard, means that the microphone will be in an improved position to pickup words spoken by the driver.

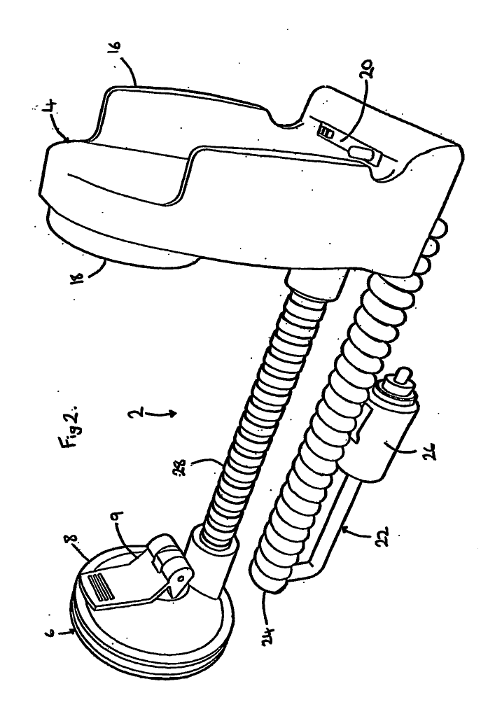

FIG. 2 illustrates an apparatus 2 that is similar to that illustrated in FIG. 1. Like reference numerals refer to like features.

The apparatus 2 of FIG. 2 comprises a spacing member in the form of a flexible spacing rod 28 in place of the rigid rod 10 and knuckle joint 12 of FIG. 1.

The flexible spacing rod 28 is constructed from a material which allows flexion of the rod 28 in three dimensions to accurately position the support frame 16 when the apparatus 2 is attached to the windscreen of a vehicle. The material may be an electrical material, rubber, soft metal or alloy, a flexible plastics material, or any combination thereof. The driver of the vehicle simply grasps the support frame 16 or rod 28 and adjusts the apparatus to the desired position. Use of the apparatus 2 of FIG. 2 is as described for FIG. 1, except for movement of the support frame 16 via the flexible rod 28, as described above.

The support frame 16 may further comprise a microphone, as described for the FIG. 1 apparatus.

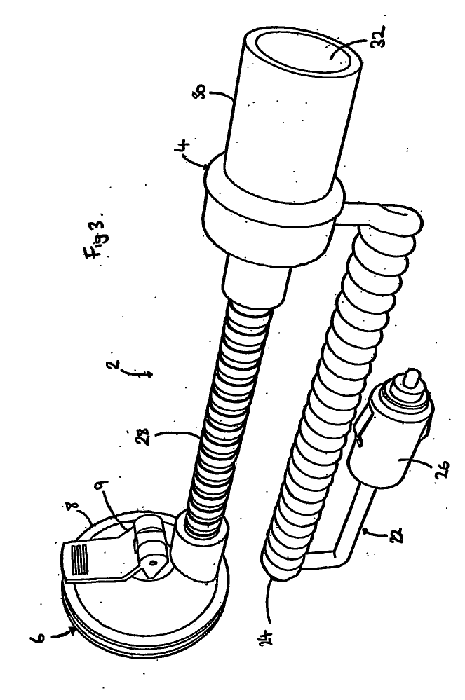

FIG. 3 illustrates an apparatus 2 that is similar to that illustrated in FIG. 2. Like reference numerals refer to like features.

The apparatus 2 of FIG. 3, comprises a socket 30 comprising a hollow cavity 32, in place of the support frame 16 of FIG. 2.

The hollow cavity 32 is in electrical connection with the electrical cable 24 and plug 26.

In use of the apparatus 2 of FIG. 3, instead of a mobile phone being connected directly to the apparatus 2, a separate support frame (not shown) or existing technology mobile phone holder (not shown) is plugged in the socket 30. A mobile phone can then be connected to the attached frame or holder.

Use of the apparatus 2 of FIG. 3 is identical to use of the apparatus 2 of FIG. 2 except for the connection of the separate support frame or holder as described above.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1-32. (Cancelled)

33. A mobile phone support apparatus comprising a mobile phone support member and a mounting member for detachably mounting the apparatus to a windscreen of a vehicle, the apparatus further comprising at least one speaker oriented such that, when the apparatus is mounted on the windscreen of a vehicle, the speaker faces towards the windscreen.

34. A mobile phone support apparatus as claimed in claim 33, wherein the mobile phone support member comprises support frame dimensioned to support a mobile phone.

35. A mobile phone support apparatus as claimed in claim 33, wherein the mobile phone support member comprises attachment means to enable attachment of a mobile phone to the support member.

36. A mobile phone support apparatus as claimed in claim 33, wherein the apparatus comprises means for connecting the speaker to the speaker of an attached mobile phone.

37. A mobile phone support apparatus as claimed in claim 33, wherein the apparatus comprises a microphone.

38. A mobile phone support apparatus as claimed in claim 37, wherein the microphone is oriented such that when the apparatus is mounted on a vehicle the microphone faces substantially towards the driver of the vehicle.

39. A mobile phone support apparatus as claimed in claim 37 wherein the apparatus comprises means for connecting the microphone to the microphone of an attached mobile phone.

40. A mobile phone support apparatus as claimed in claim 33, wherein the support member comprises a socket or bracket arranged in use, to receive a separate support frame, which in use, is arranged to support a mobile phone.

41. A mobile phone support apparatus as claimed in claim 33 wherein the mounting member comprises a suction pad.

42. A mobile phone support apparatus as claimed in claim 41, wherein the suction pad comprises means to engage and release suction of the suction pad on the window of a vehicle, when the suction pad contacts the window.

43. A mobile phone support apparatus as claimed in claim 42, wherein the means for engaging and releasing suction comprises a lever arranged to move between a first position in which at least part of the lever exerts pressure against the suction pad to effect suction when the pad contacts the window of the vehicle, and a second position in which the pressure is released to allow release of the suction pad.

44. A mobile phone support apparatus as claimed in claim 33, wherein the mounting member is directly connected to the support member.

45. A mobile phone support apparatus as claimed in claim 33, wherein the mounting member is spaced apart from the support member by way of a spacing member.

46. A mobile phone support apparatus as claimed in claim 45, wherein the spacing member at one end is connected to the mounting member, and at another end is connected to the support member.

47. A mobile phone support apparatus as claimed in claim 45, wherein the spacing member comprises a rigid member.

48. A mobile phone support apparatus as claimed in claim 47, wherein the rigid spacing member is connected to the support member by way of a moveable joint or hinge.

49. A mobile phone support apparatus as claimed in claim 45, wherein the spacing member is flexible member.

50. A mobile phone support apparatus as claimed in claim 49, wherein the flexible spacing member allows relative movement between the support member and the mounting member in three dimensions.

51. A mobile phone support apparatus as claimed in claim 45, wherein the spacing member is telescopic to allow movement of the support frame towards and away from the window when the apparatus is attached to the window.

52. A mobile phone support apparatus as claimed in claim 33, further comprising means to connect the apparatus to a vehicle cigarette lighter socket.

53. A mobile phone support apparatus as claimed in claim 52, wherein the cigarette lighter socket connection means comprises a plug dimensioned to substantially sealingly fit the cigarette lighter socket of a vehicle.

54. A mobile phone support apparatus as claimed in claim 52, wherein the cigarette lighter socket connection means further comprises means to electrically couple the socket to the support member of the apparatus.

55. A mobile phone support apparatus as claimed in claim 52, wherein the cigarette lighter socket connection means is connected to the support member.

56. A mobile phone support apparatus as claimed in claim 55, wherein the cigarette lighter socket connection means is connected to the support member by way of a spacing member.

57. A mobile phone support apparatus as claimed in claim 56, wherein the spacing member is a flexible spacing member the length of which can be extended and reduced, to allow connection of the cigarette lighter socket connection means to the cigarette lighter socket of a vehicle when the apparatus is attached to the window of a vehicle in varying positions.

58. A mobile phone support apparatus as claimed in claim 57, wherein the flexible spacing member is an electrical power cord.

59. A method of mounting a mobile phone to the interior of a vehicle, the method comprising the steps of:
(a) providing a mobile phone support apparatus of claim 33;
(b) mounting a mobile phone in the support member; and
(c) attaching the support member to the windscreen of the vehicle.

60. A method as claimed in claim 59 wherein steps (b) and (c) are temporally interchanged.

61. A method as claimed in claim 59, wherein the method further comprises the step of electrically connecting the mobile phone to the cigarette lighter socket of the vehicle, which step may be performed at any point in the method.

62. A kit of parts comprising a mobile phone support apparatus of claim 33 and a mobile phone.
